(19) United States
(12) Patent Application Publication
(10) Pub. No.: US 2005/0209924 A1
(43) Pub. Date: Sep. 22, 2005

(54) Operation process item setting system for POS system

(75) Inventor: Hiroyasu Hasegawa, Kanagawa (JP)

Correspondence Address: FOLEY AND LARDNER;SUITE 500, 3000 K STREET NW, WASHINGTON, DC, 20007, US

(73) Assignee: NEC Infrontia Corporation

(21) Appl. No.: 11/063,728

(22) Filed: Feb. 24, 2005

(30) Foreign Application Priority Data
Feb. 18, 2003 (JP) 2003-039772

(51) Int. Cl. G06F 17/60

(52) U.S. Cl. 705/16

(57) ABSTRACT

An operation process item setting system for POS system includes a check table with table-type-stored set-up therein of POS system operation process items and items indicative of whether the respective operation processes are necessary. Designation as to whether the operation process of an operation process item stored in the check table is made with an input means for causing the operation of the designated operation process item. The operation process items at the time of opening the shop are a cash drawer change registration process, and the operation process items at the time of closing the shop are a cash drawer money amount register process, a non-settled slip closing process or a present stock-managed goods stock input process.

### BACKGROUND OF INVENTION

The present invention relates operation process item setting systems for POS system, for instance an operation process item setting system for POS system capable of improving the operability at the times of opening and closing a shop with POS system.

In fast food shops, convenience stores, etc. with the POS system, various processes have to be executed at the times of starting and end ending POS system utilization (i.e., at the times of opening and closing a shop). For example, it is in many cases necessary to execute a cash drawer change register process at the time of opening the shop. Also, in many cases it is necessary, at the time of closing the shop, to execute a cash drawer cash amount register process, a non-settled slip closing process, and a present stock goods stock input process.

In the prior art shops with POS system, the POS system software producer side has coped with the execution of such processes by preliminarily obtaining data of shop's desires, producing programs suited to the desires and storing the programs in the system or updating the programs after storing thereof.

However, at the times of start and end of the POS system operation (at the times of opening and closing the shop), not only it is necessary to execute various processes but also addition of necessary processes and deletion of processes are involved in dependence on the kind and/or status of the shop. Whenever a program updating for process change or addition arises, it has to be requested to a system building dealer. Therefore, quick coping is impossible, and also cost problems are posed. More specifically, at the daily times of opening and closing the shop, various processes have to be executed in dependence on the shop (i.e., status and business kind of the shop). In many cases, the processes include a number of processes executed manually by a shop manager or employee. This means that workability and operability problems are posed. Also, as for the POS system program a process routine conforming to each shop is produced separately to permit execution of processes conforming to the shop, thus giving rise to quickness and cost problems.

For example, in the case that there are two different processes to be executed at the time of opening the shop and eight different processes to be executed at the time of closing the shop, a total of sixteen different process combinations are involved. Therefore, whenever changing even only one of the process combinations in dependence on a variety of shop statuses and frequent changes thereof, a program change has to be requested to an expert dealer. Obviously, quickness and cost problems are posed. The above problems are not only limited to the processes executed at the times of opening and closing the shop but also posed in the case of any other process.

### SUMMARY OF INVENTION

The present invention has made in view of the above background circumstances, and it has an object of providing an operation process item setting system for POS system capable of easy and quick designation of operation process items at the times of starting and ending the use of the POS system (i.e., at the times of opening and closing the shop) without need of special expert process execution.

As an embodiment of the present invention, is provided an operation process item setting system for POS system comprising a check table with table-type-stored set-up therein of POS system operation process items and items indicative of whether the respective operation processes are necessary, wherein designation as to whether the operation process of an operation process item stored in the check table is made with an input means, thereby causing the operation of the designated operation process item.

As a different embodiment of the present invention, is provided an operation process item setting system for POS system comprising a check table with table-type-stored set-up therein of POS system operation process items and items indicative of whether the respective operation processes are necessary and also with table-type-stored set-up of operation process items and items indicative of whether the respective operation process items have been executed, wherein designation as to whether the operation process of an operation process item stored in the check table is made with an input means, thereby causing the operation of the designated operation process item.

The POS system is adopted in a shop, and the operation process items are those at the times of opening and closing the shop. The operation process items at the time of opening the shop are a cash drawer change registration process, and the operation process items at the time of closing the shop are a cash drawer money amount register process, a non-settled slip closing process or a present stock-managed goods stock input process. The error display is made in the case of failure of operation of an operation process item set up in the check table. The input means is a touch panel, and the designation is made by touching a predetermined key on the touch panel.

Other objects and feature of the present invention will be clarified from the following description with reference to the attached drawings.

### BRIEF DESCRIPTION OF DRAWINGS

FIG. 1 is a flow chart illustrating flow of process at the time of opening or closing a shop in the operation process item setting system for POS system according to the present invention;

FIGS. 2 and 3 are views showing operation process item views of whether execution is necessary and whether execution has been over;

FIG. 4 is a view showing an example of check table for shop management in the embodiment of the present invention;

FIG. 5 shows a different example of shop management; and

FIG. 6 is a view showing an error display in the case when a shop is closed without execution of necessary processes set up in the embodiment of the present invention.

### PREFERRED EMBODIMENTS OF INVENTION

Now, a preferred embodiment of the operation process item setting system for POS system according to the present invention will now be described in detail with reference to the accompanying drawings.

In the present invention, a check table is prepared as memory in the POS system, and operation process items to be possibly called at the times of opening and closing a shop are stored in the check table. The check table is displayed as usual POS system input view to permit easy set-up of a necessary operation process item based on designation thereof.

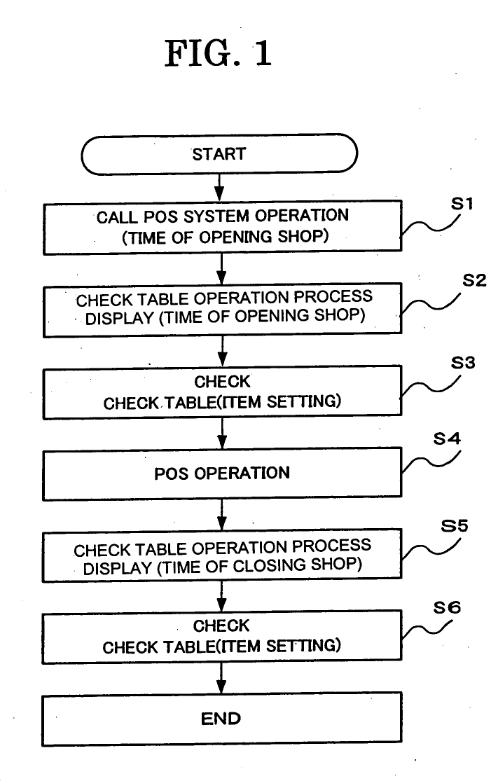

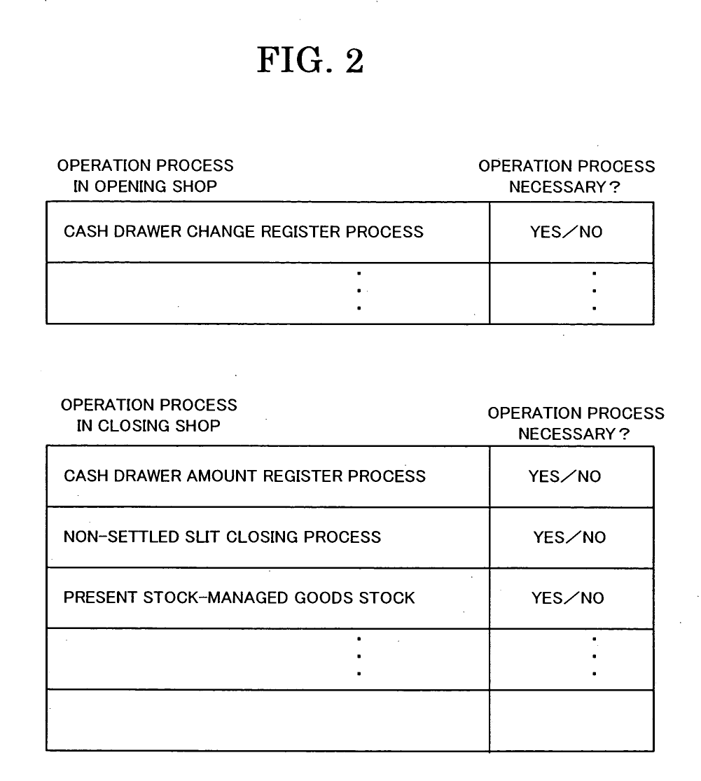

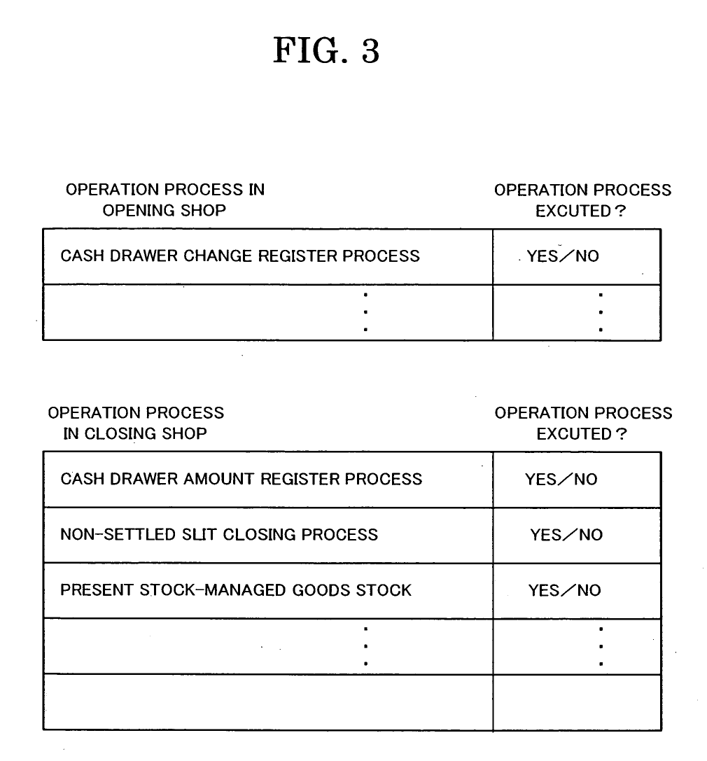

FIG. 1 is a flow chart illustrating the flow of process at the time of opening or closing a shop in the operation process item setting system for POS system according to the present invention. FIGS. 2 and 3 are views showing operation process item views of whether execution is necessary and whether execution has been over.

In the check table shown in FIG. 2, at the time of opening the shop, operation process item views of whether a cash drawer change register process and so forth are necessary (YES/NO) are displayed. At the time of closing the shop, operation process item views of whether a cash drawer amount register process, a non-settled slit closing process, a present stock-managed goods stock input process and so forth are necessary (YES/NO) are displayed. In the case of a touch panel used as display, the designation is made by touching a corresponding one of the (YES/NO) parts. In the case of using no touch display as display, the designation is made by a predetermined key operation.

In the check table shown in FIG. 3, at the time of opening the shop, operation process item views of whether the cash drawer change register process and so forth have been executed (YES/NO) are displayed. At the time of closing the shop, th present cash drawer money amount register process, the non-settled slip closing process, the present stock-managed goods stock input process and so forth have been executed (YES/NO) are displayed. When a flag of (YES) indicative of a necessary process and also a flag of “NO” indicative of an executed process are present, an error display is made. This arrangement has an effect of preventing the erroneous opening or closing of the shop.

The routine in the operation process item setting system for POS system according to the present invention from the start till the end of the operation will now be described with reference to FIG. 1.

When the POS system operation is called at the time of opening the shop (step S1), the check table operation process item view is displayed as shop-opening time view in FIG. 2 on the display (step S2). On this view, as described above, designation as to whether it is necessary (YES/NO) to execute the cash drawer change register process at the time of opening the shop is made with key touch or like input means (step S3). Subsequently, usual operation is brought above by causing duty service of the POS system (step S4).

At the time of closing the shop, the check table operation process item view is displayed as shop-closing time view in FIG. 2 on the display (step S5). On this view, as described above, designation as to whether it is necessary (YES/NO) to execute some of the cash drawer money amount register process, the non-settled slop closing process, the present stock-managed goods stock input process and so forth at the time of closing the shop, is made with touch keys or the like (step S5), thus bringing an end to the system operation.

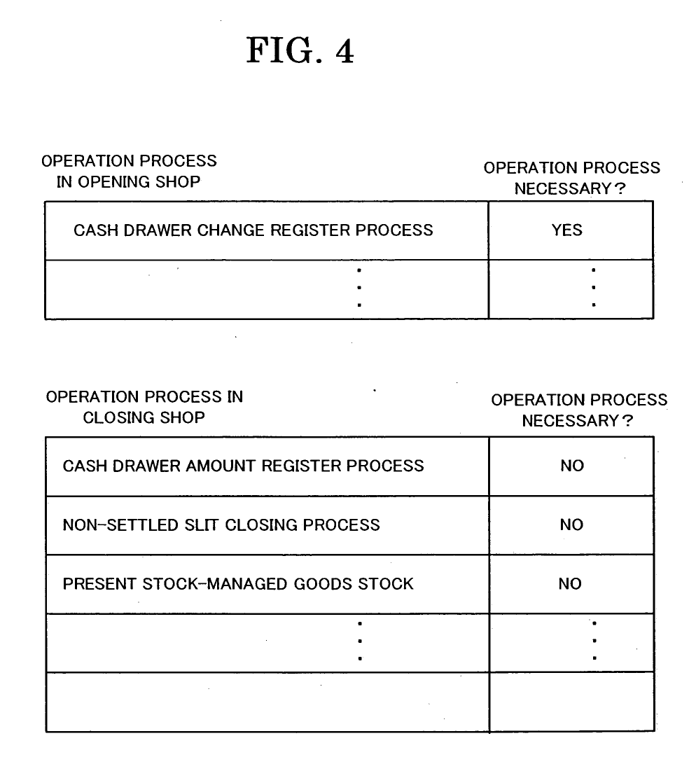

FIG. 4 shows an example of shop management. In this example, such check table set-up is made that the cash drawer change register process at the time of opening the shop is executed (YES) while stock management is not made in the POS system, that is, the cash drawer cash amount register process, the non-settled slip closing process and so forth.

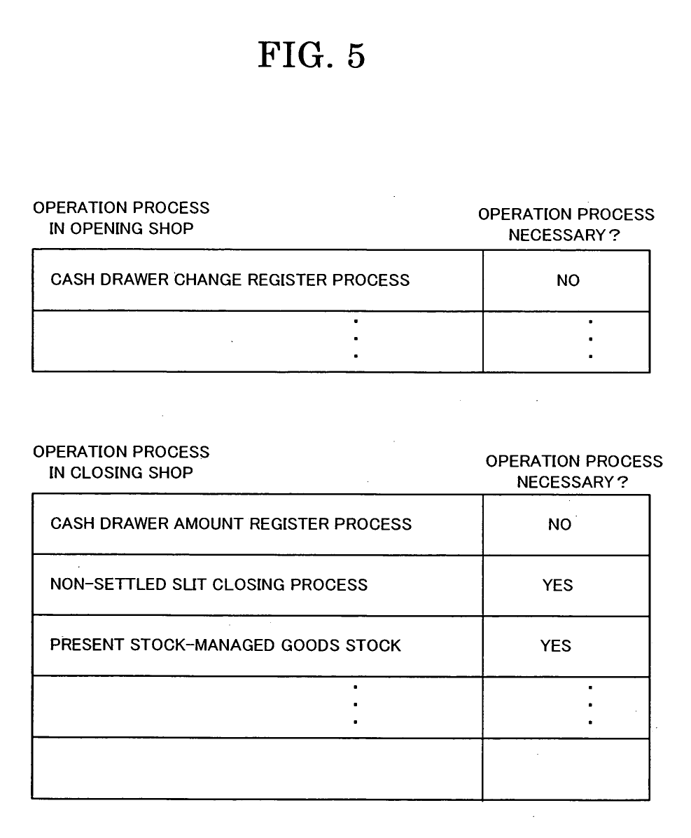

FIG. 5 shows a different example of shop management. In this example, at the time of opening the shop the cash drawer change register process is not executed (NO), and at the time of closing the shop in the presence of non-settled slips the POS system executes stock management without allowance. In other words, such check table set-up is executed that the cash drawer change amount register process is not executed (NO) while executing the non-settled slip closing process and the present stock-managed goods stock input process (YES).

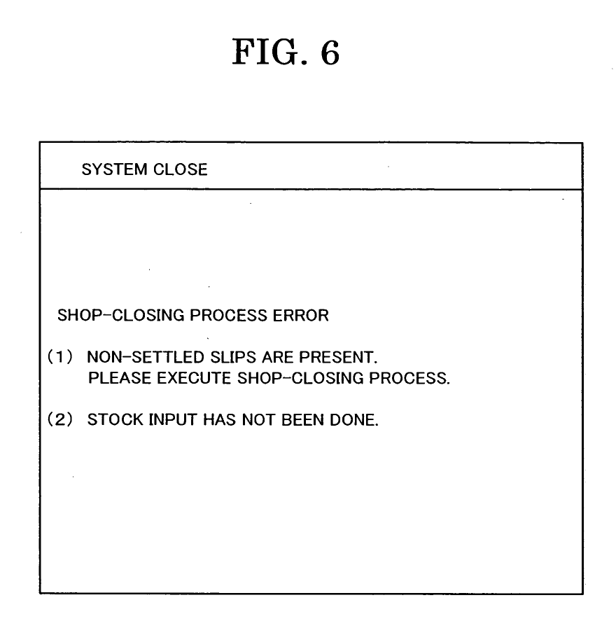

In this embodiment, when the shop is opened or closed (i.e., the POS system is started or ended) without execution of the necessary processes set up with reference to the operation process set-up item in the check table, a list as shown in FIG. 6 is displayed. This arrangement permits readily visually confirming, from error display, a process which is not executed so that the shop can not be opened or closed. In the example in FIG. 6, as a shop-closing process error, the following display is made.
(1) Non-settled slips are present. Please execute shop-closing process.
(2) Stock input has not been done

As has been described in the foregoing, according to the present invention at the times of starting and ending the POS system operation, the check table operation process items are displayed as display view for designation and set-up as to whether it is necessary to execute desired operation process items. Thus, only it is necessary the designation on the view by shop side user (such as employee or master having no expert knowledge), that is, no program customization by any expert is necessary. It is thus possible obtain quick operability and great effect of cost improvement. More specifically, it is possible to set up, from the check table in the display view, whether execution of execution items is necessary (TES/NO) at the time of opening and closing the POS system shop. It is thus possible to unify programs toa single one. Also, it is possible to dispense with the set-up by any program dealer or like expert and also realize speed increase and cost reduction. Furthermore, like the case of the version-up, it is readily possible to update program and obtain version management. With these merits, the support of branches and agents dealing with programs can be facilitated. Moreover, in the case when the shop is opened or closed (i.e., the POS system operation is started or ended) without execution of necessary processes set up in the check table, a list of what happened is displayed, thus permitting ready visual confirmation, from error display, of a process which is not executed so that the shop can not be opened or closed.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

1. An operation process item setting system for POS system comprising a check table with table-type-stored set-up therein of POS system operation process items and items indicative of whether the respective operation processes are necessary, wherein:
designation as to whether the operation process of an operation process item stored in the check table is made with an input means, thereby causing the operation of the designated operation process item.

2. An operation process item setting system for POS system comprising a check table with table-type-stored set-up therein of POS system operation process items and items indicative of whether the respective operation processes are necessary and also with table-type-stored set-up of operation process items and items indicative of whether the respective operation process items have been executed, wherein:
designation as to whether the operation process of an operation process item stored in the check table is made with an input means, thereby causing the operation of the designated operation process item.

3. The operation process item setting system for POS system according to claim 1, wherein the POS system is adopted in a shop, and the operation process items are those at the times of opening and closing the shop.

4. The operation process item setting means for POS system according to claim 1, wherein the operation process items at the time of opening the shop are a cash drawer change registration process, and the operation process items at the time of closing the shop are a cash drawer money amount register process, a non-settled slip closing process or a present stock-managed goods stock input process.

5. The operation process item setting system for POS system according to claim 1, wherein error display is made in the case of failure of operation of an operation process item set up in the check table.

6. The operation process item setting system for POS system according to claim 1, wherein the input means is a touch panel, and the designation is made by touching a predetermined key on the touch panel.
